(19) United States
(12) Patent Application Publication
(10) Pub. No.: US 2020/0395008 A1
(43) Pub. Date: Dec. 17, 2020

(54) Personality-Based Conversational Agents and Pragmatic Model, and Related Interfaces and Commercial Models

(71) Applicants: Jessica Cohen, Niagara Falls, NY (US); Ernesto Yao Zhong, Mississauga (CA); Valerio Basile, Rome (IT)

(72) Inventors: Jessica Cohen, Niagara Falls, NY (US); Ernesto Yao Zhong, Mississauga (CA); Valerio Basile, Rome (IT)

(73) Assignee: Very Important Puppets Inc., Niagara Falls, NY (US)

(21) Appl. No.: 16/442,495

(22) Filed: Jun. 15, 2019

(51) Int. Cl. G10L 15/19; G10L 15/18; G10L 15/16; G10L 15/30; G06F 17/27; G10L 15/22

(52) U.S. Cl. CPC G10L 15/19; G10L 15/1822; G10L 15/1815; G10L 15/16; G10L 15/30; G10L 2015/223; G06F 17/274; G06F 17/2785; G06F 17/2705; G06F 17/277; G10L 15/22; G06F 17/2755

(57) ABSTRACT

Whereas contemporary chatbots use conversation as a means to execute a task, the present invention generates conversation as an enjoyable interaction central to the human experience. A conversational API is modeled on speech from real or fictitious personalities, and enables humorous and useful conversation, music streaming, digital assistant tasks with humans or other agents. The present invention affords a richer, more human level of conversation over corporate, generic digital devices and assistants. The API is comprised of speech input, which is fed into a natural language understanding (NLU) pipeline, which is trained on a corpus of labeled speech samples harvested from the speaker by means of a neural network, or pragmatic model; the speech is then fed into a personality model, then into a natural language generation (NLG) pipeline, from which speech is selected from a database and modified, to emit a reply. The pragmatic model consists of a detailed and subtle labeling model, and pairing model, wherein input and output sentences are labeled according to a rich classification system of tonal and semantic nuances. The personality model exhibits a predetermined preference for certain tonal, intentional and functional labels according to that personality, which has been trained on labeled speech input in the pragmatic model. Labels include lexical, semantic, syntactic, demographic, contextual and voice attributes, to create a range of identifiable personas. Varied instances of personality models create a library of artificially intelligent conversational models, or personality fonts, which are distinct from each other in terms of conversation style. A user may interact with a conversational agent as a formless digital agent, or chatbot. These caricatured personalities may also take on a skeuomorphic or anthropomorphic form, as a talking physical device which caricatures a known person or fictitious character. Users may further personalize their agent instance from the library, by means of adding digital swag or assets to a digital representation of the avatar; or operating their avatar in a simulation game room or chat lobby, whereby accumulating points, audience, or experiences specific to their instance. The API may also stream music playlists, selected according to common themes in the music and the personality model; or, if the personality model is based on a musician, API may stream the musician's works.

### RELATED INTELLECTUAL PROPERTY CLAIMED AS PART OF THIS APPLICATION

Copyright Application #1-6101841221 “Political Action Figures”, Assignee Very Important Puppets Inc., of Niagara Falls N.Y.

US Trademark Application #87751076 “VIP VERY IMPORTANT PUPPETS”, Assignee Very Important Puppets Inc., of Niagara Falls N.Y.

US Trademark Application #88012274, “Artificial Intelligence Meets Bobbleheads AIXB”, Assignee Very Important Puppets Inc., of Niagara Falls N.Y.

### LIST OF THE DRAWINGS

FIG. 1 is a flow chart showing the conversational model as described in Claims 1-8.

FIG. 2 is a simplified flow chart showing the conversational model of FIG. 3 as described in Claims 1, 2, and 4.

FIG. 3 is a flow chart showing how the conversational model of Claim 1 is trained.

FIG. 4 shows how data flows between a conversational device of Claim 13, a smartphone and a cloud computing service hosting data and services associated with Claim 1.

FIG. 5 shows one embodiment of the devices of Claim 13 in the caricatured likeness of three politicians.

FIG. 6 shows the home screen of a smartphone application designed to pair with and operate the devices of Claim 13.

FIG. 7 shows a screen of a smartphone app of Claims 14-17, which enables a user to register a unique profile and avatar, and also provide payment options for in-app purchases of Claim 19, wherein payment options include cryptocurrency. The app screen's bottom navigation menu shows 5 buttons, which refer to conversation (Claims 1-8), dictation (Claim 14), messaging (Claim 15), music streaming (Claim 17), and gaming.

FIGS. 8 and 9 show the main menus of the smartphone app of Claims 14-17, which include buttons for setting alarms, conversing with a conversational agent, pairing a new device, updating avatar profile, playing music, sending pre-recorded messages, playing competitive games, and dictating through the device of Claim 13.

FIGS. 10 and 11 show screens from the app of Claims 17 which enable the user to set an alarm with a ringtone associated with the voice of a selected agent.

FIG. 12 shows a screen from the app workflow for conversing with an agent, in which a user may select a paired agent to converse with.

FIG. 13 shows the record of a spoken conversation between a person and a device of Claim 13.

FIGS. 14, 15, 16, and 17 show the workflow of a smartphone app in which a user may compose a message of text and emoticons, and select the voice of an agent, and generate a voice message by converting the text into audio, as described in Claim 15.

FIG. 18 shows an app screen for the initial pairing between the device of Claims 13 and a smartphone, with graphic indications of devices which are actively paired; the app screen shows 5 navigational icons at the bottom of the screen, which refer to conversation (Claims 1-8), dictation (Claim 14), messaging (Claim 15), music streaming (Claim 17), and gaming.

FIGS. 19, 20, and 21 show a scrolling selection of graphic representations of conversational agents of Claim 1, which a user may select to pair with a smartphone. The app screens show 5 navigational icons at the bottom of the screen, which refer to conversation, dictation, messaging, music streaming, and gaming.

FIGS. 22 and 23 show screens in a workflow which plays music, wherein the music may selected by the user, suggested by the application in accordance with the user's taste, or in accordance with an avatar's personality, as described in Claims 17 and 18.

FIG. 24 shows a screen of the app with a comical digital avatar of a personality, wherein the user may personalize his or her avatar's instance by selecting digital adornments or props to dress the avatar, wherein said props may be for purchase as described in Claim 18.

FIG. 25 shows a screen from a 3^{rd} party chatbot application, with certain novel modifications, namely, additional fields for labeling sentences for semantic attributes such as function and topic as described in Claim 3, whereby enabling smarter matching of responses according to heuristically acceptable, pre-defined pairings of sentence function and topics.

FIG. 26 describes second embodiment of the present invention, with an interface from a 3^{rd} party application designed to enable users to craft conversations, with the added novel features of a personality matrix, as described in Claims 10 and 11, wherein each permutation is represented as a three-dimensional cube, and the matrix is represented as a three-dimensional grid of these cubes, wherein a user may preselect attributes or dimensions of a conversation style, offering a library of personality types which influence the character of a conversation.

FIG. 27 describes second embodiment of the present invention, with a flowchart of the conversational algorithm described in Claims 10, 11, and 12, which is substantially similar to the first embodiment of Claims 1-8, however the dynamic personality modeling is replaced by a static library of conversational styles.

FIG. 28 is a flow chart of the messaging workflow described in Claim 14.

FIG. 29 is a simplified flow chart of the conversation function of the smartphone app, as shown as an icon in FIG. 9, and as shown as a workflow of screens in FIGS. 12 and 13.

FIG. 30 shows two conversational devices conversing with each other, showing details of the agent algorithms as described in Claims 1-8.

FIG. 31 shows a conversational device of claim 13 with its hardware components and software ecosystem.

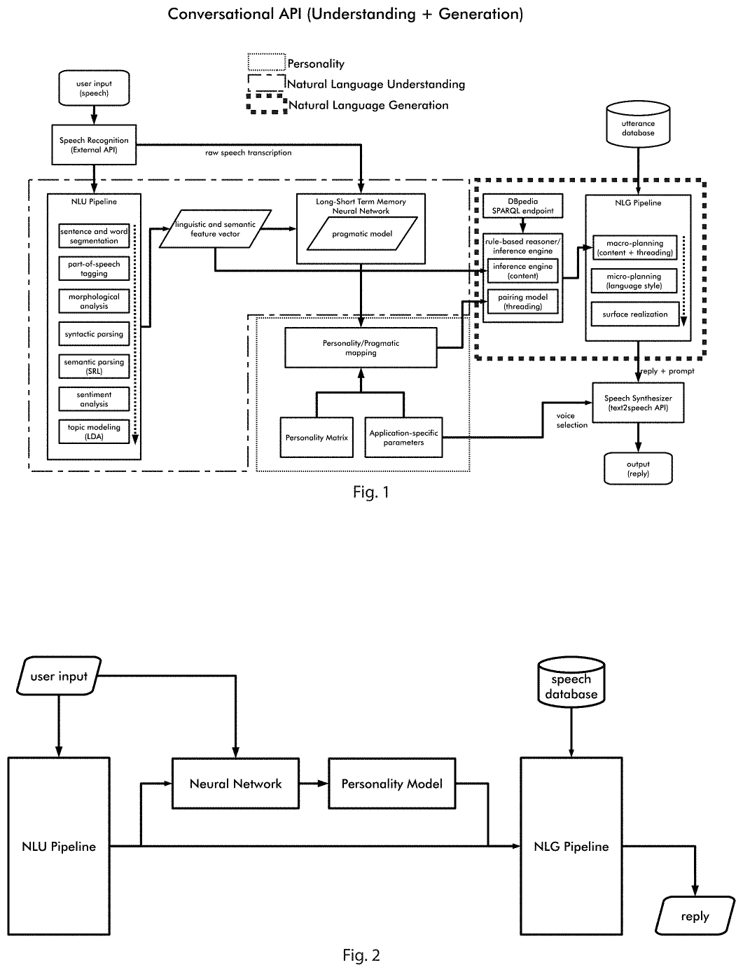

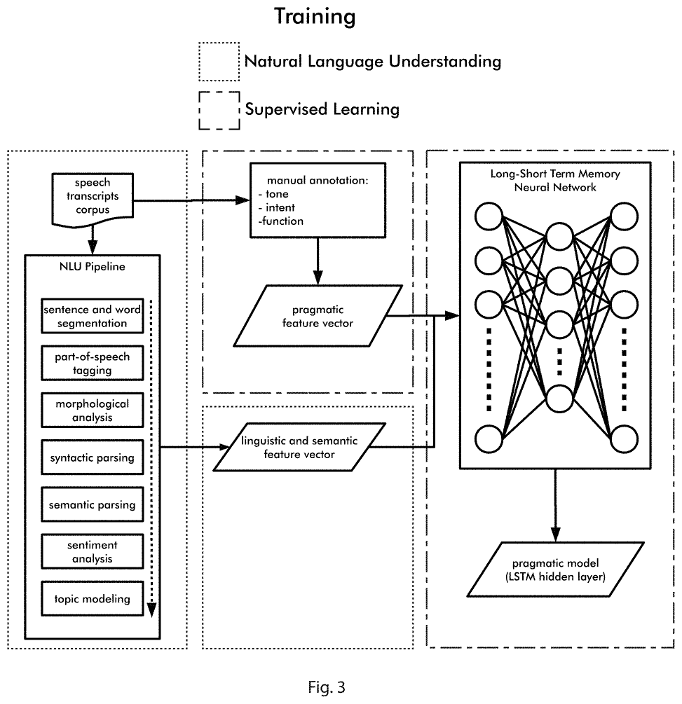

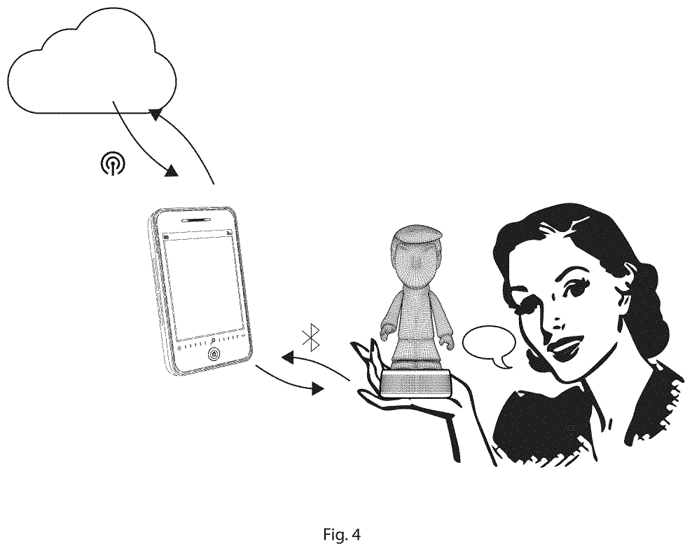

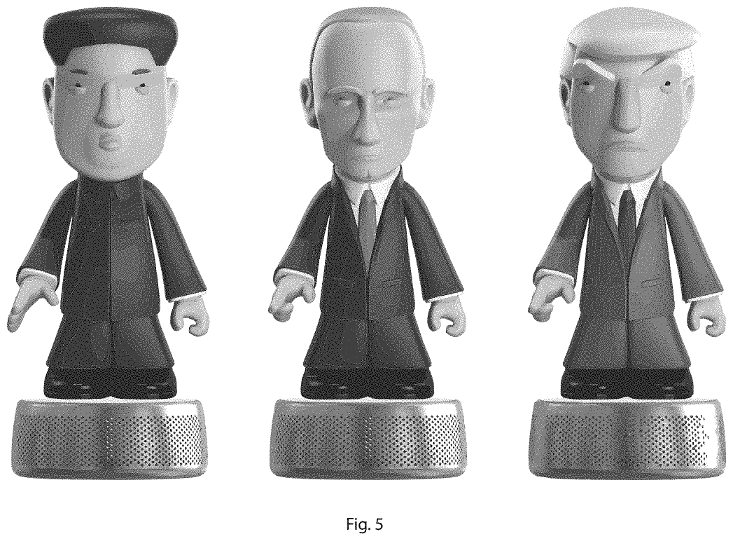

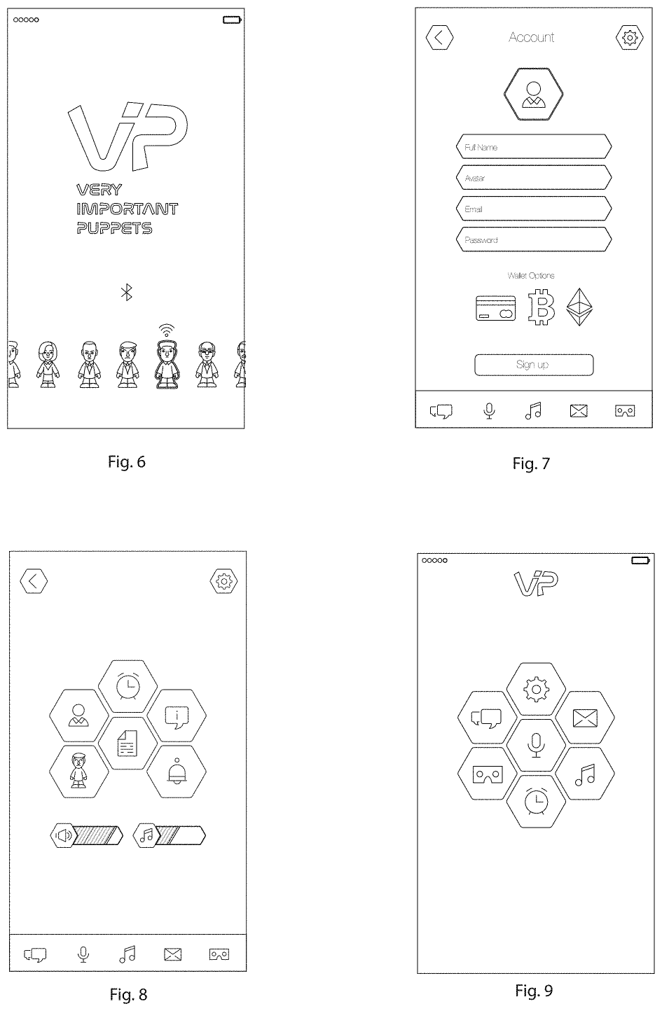

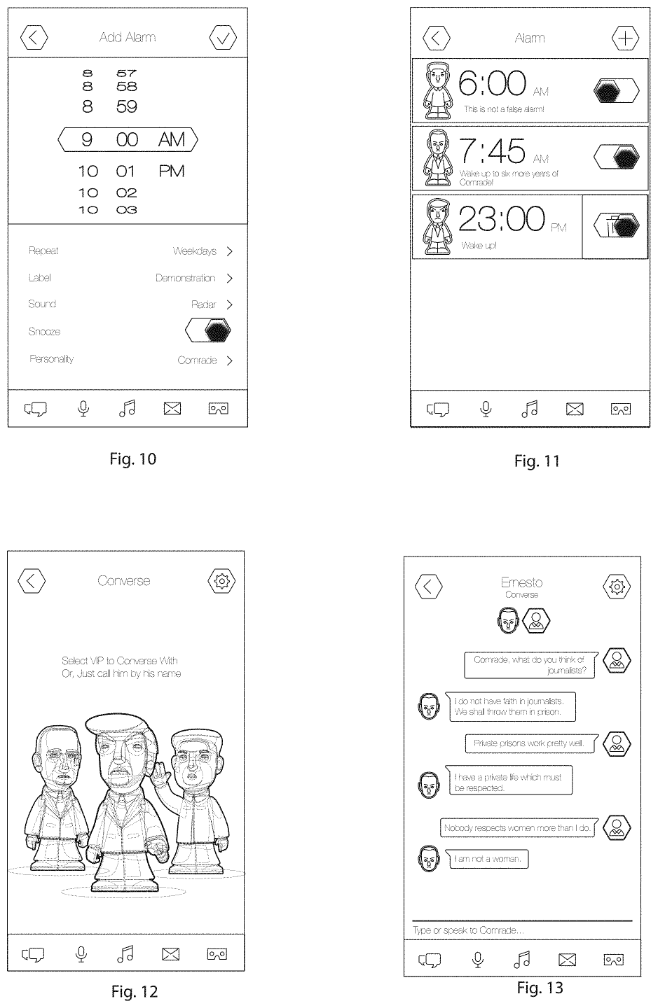

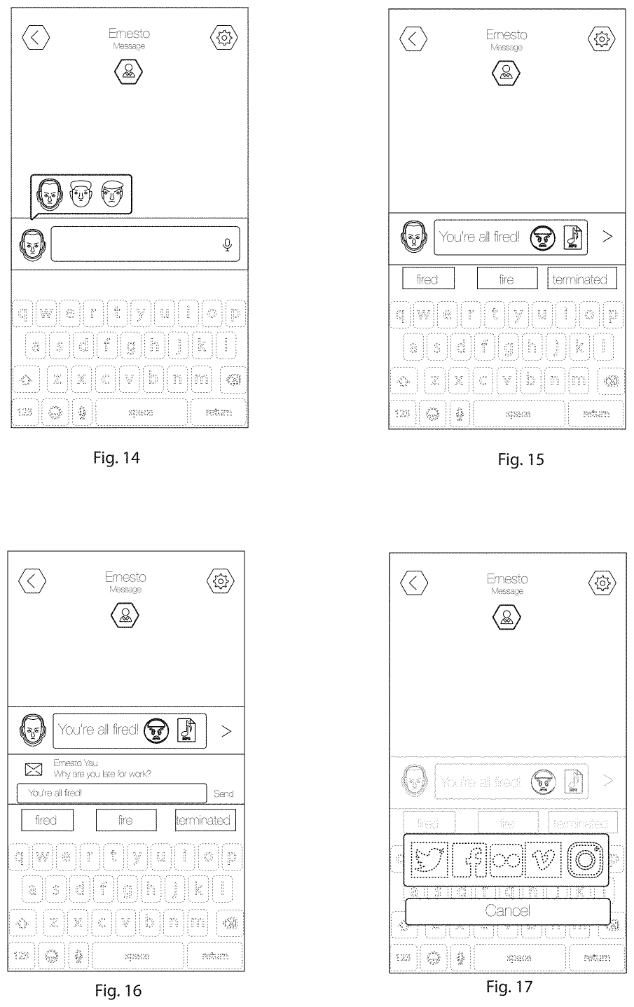

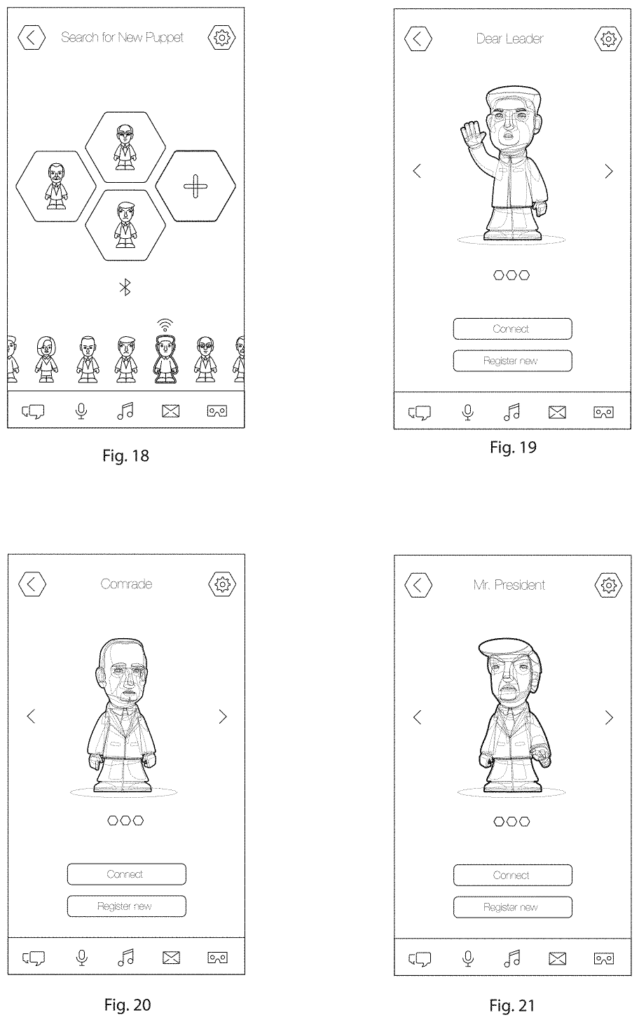

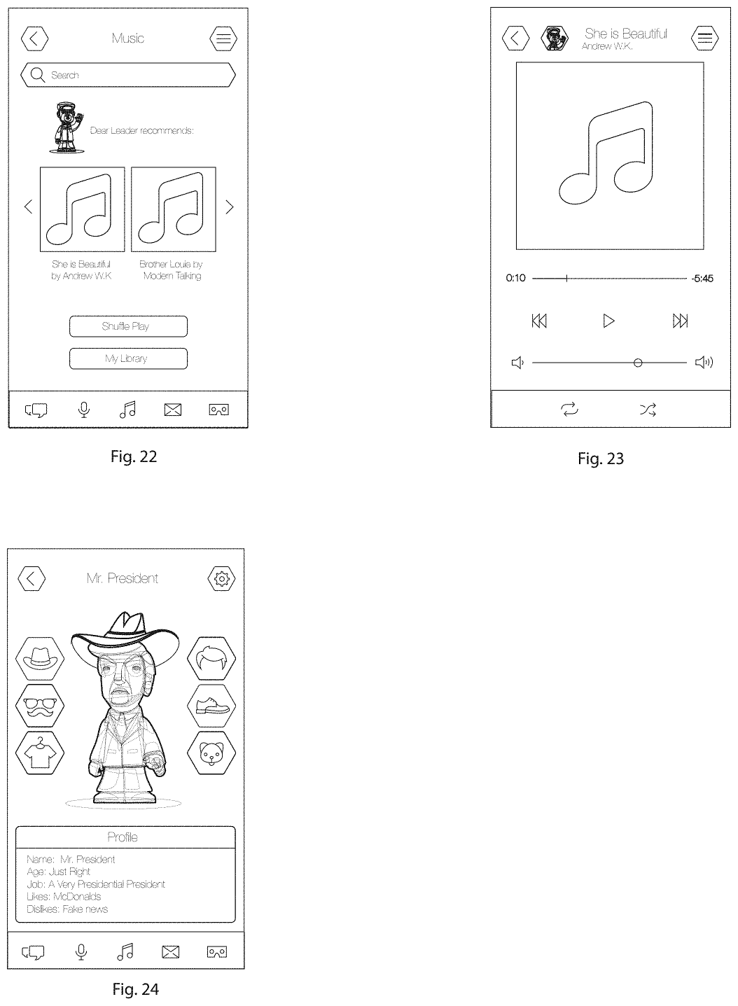

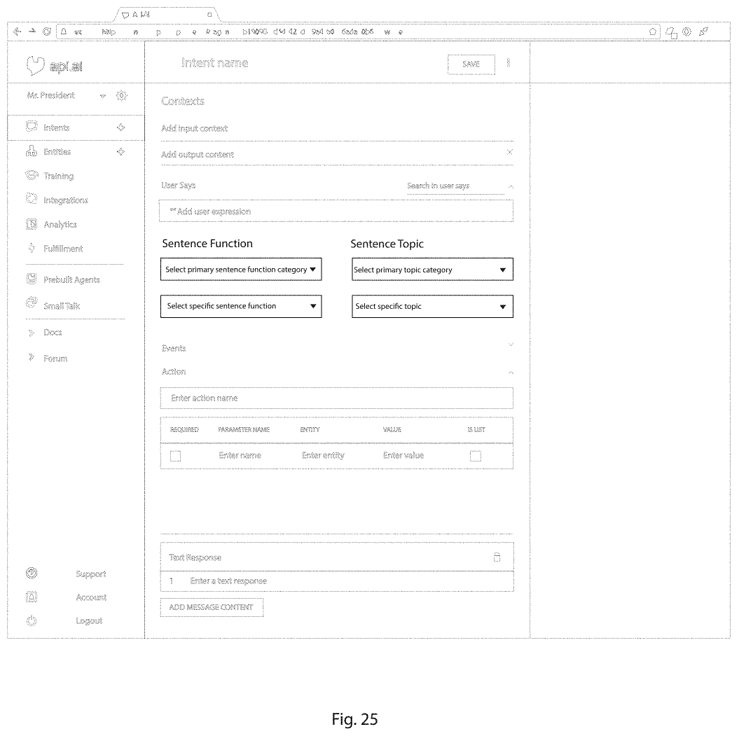

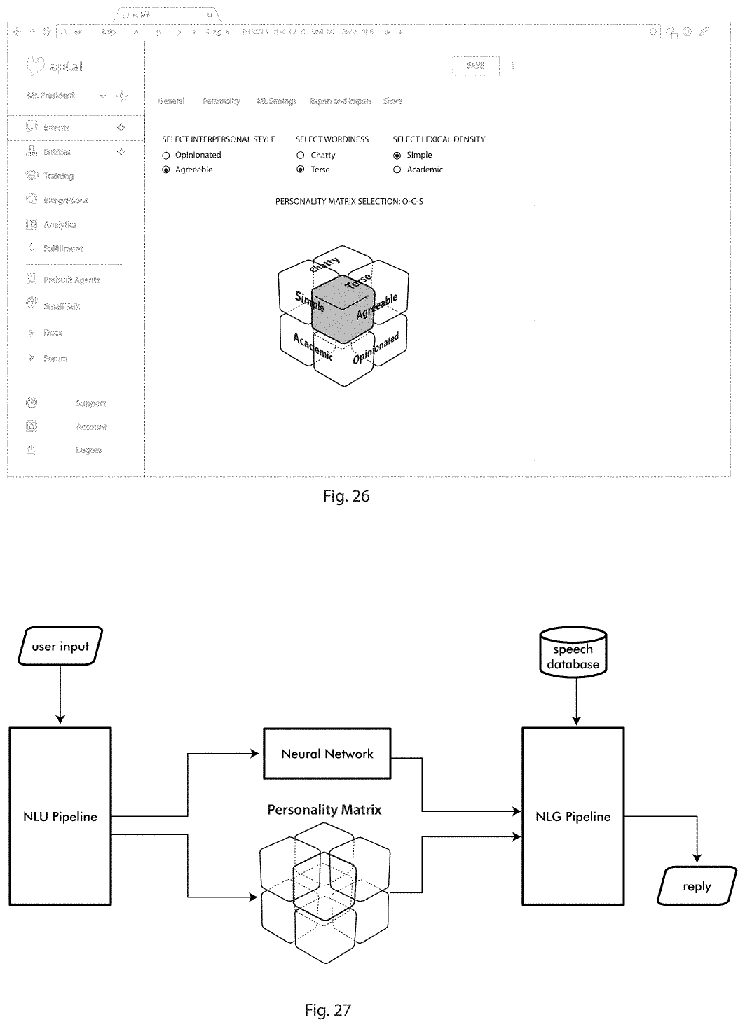

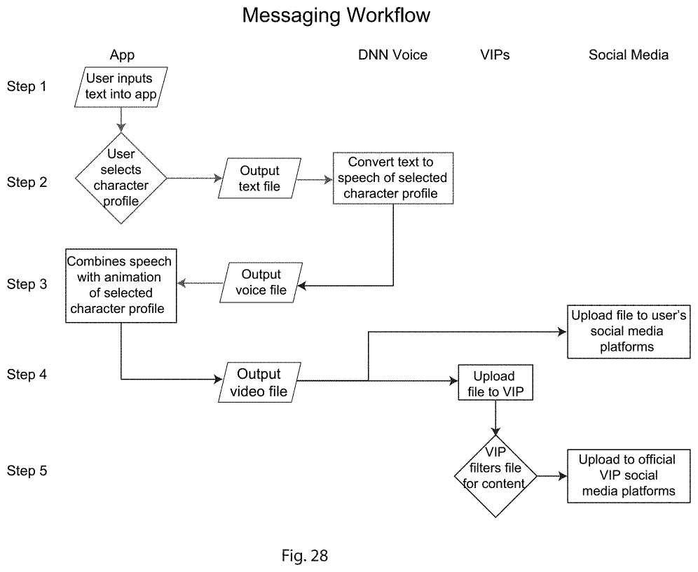

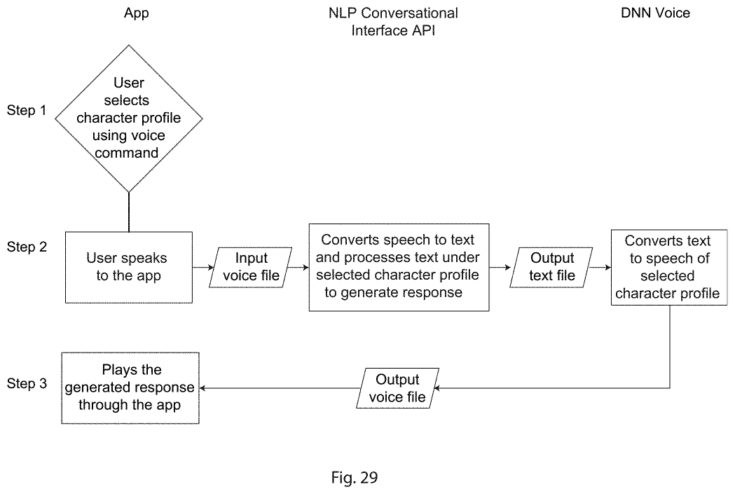

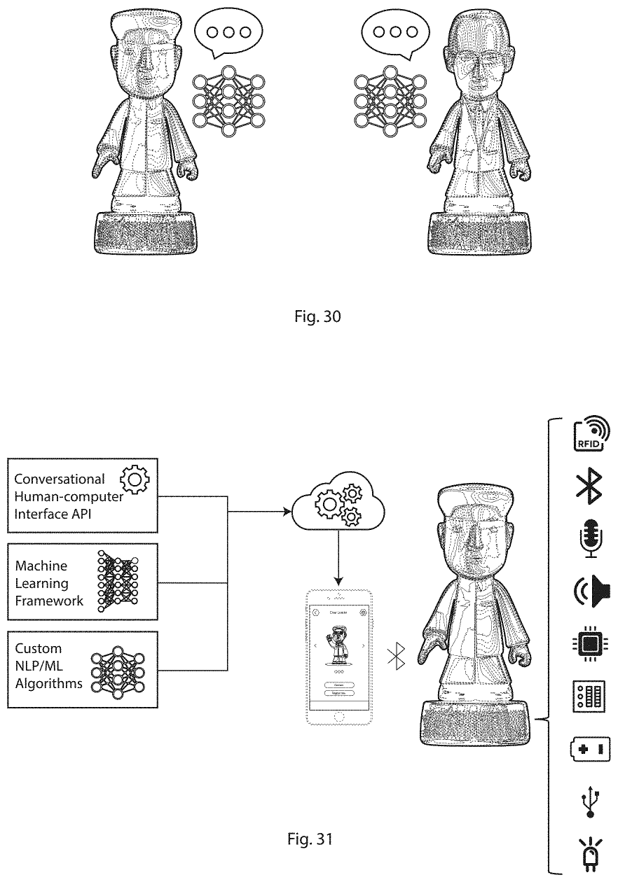

### GENERAL DEFINITIONS

Natural Language Processing (NLP): The area of Computer Science and Artificial Intelligence that deals with the representation and manipulation of human natural language from a computational perspective.

Natural Language Understanding (NLU): Subfield of Natural Language Processing that deals with the problems of interpreting the meaning of natural language and representing it in a computational format.

Natural Language Generation (NLG): The subfield of Natural Language Processing that deals with the problems of generating fluent natural language utterances from formal representations of information.

Application Programming Interface (API): Set of clearly defined and documented function definitions and protocols for building application software.

Parsing: In the context of Natural Language Processing, parsing is the process of automatically analyzing a natural language text to compose a formal representation of its syntactic structure (syntactic parsing) or its meaning (semantic parsing).

Neural Network: Computing paradigm that learn a statistical model from features representing positive and negative examples, and predicts features of unseen instances by generalizing its internal representation.

Feature vector: In order to be processable by automated algorithms, the features of a text or a speech must be univocally encoded in a fixed-size numeric vector, called a feature vector.

Training: In the context of supervised machine learning, training is the process of feeding a statistical model (e.g., a neural network) with a large quantity of labeled examples, in order to compute a generalized statistical model from the data.

Pragmatic: Pragmatics is the area of linguistics and semantics that studies the relationship between utterances and their context, including the speaker's intentions, beliefs and implicatures. Pragmatic features of a text are features encoding the aspects of the text relevant to pragmatics.

Tweet: Short text message broadcast publicly on the popular microblogging platform Twitter (https://twitter.com).

While the use of chatbots in commercial websites and standalone tools like Amazon Echo is becoming commonplace, all these systems focus on parsing the natural language from the user's query and producing the right answers or executing commands in the tersest, most correct language. These are desirable properties, of course, but the unidimensional scope of the technology involved creates an army of bots all with the same style of conversation. They are generic and boring, resembling more old-style robots than human-like companions with our quirks and unique style. Users hesitate to interact with these robotic personalities because the conversation does not flow. There is no skeuomorphic, or ‘oh-so-human’ experience. The elements of humor and idiosyncratic personality are missing. A more personalized, customized user interface is needed for virtual assistants.

We reference this dialogue with a recent winner of the Loebner Prize, a Turing Test competition for chatbots:
User: What is going on?
Chatbot: Nothing much you?
User: Great
Chatbot: Glad to hear it. Can I help you with something?
User: I want to book a bus.
Chatbot: You should contact the bus company then.

Despite the friendly interaction, the conversation lacks a taste of human factor, for example a humorous remark. The chatbot also appears to lack empathy for its human counterpart, or interest in solving the human's problem.

We introduce a novel concept for virtual assistants whose main novel feature is the integration of custom personalities to generate human-like dialogue acts. We introduce a new way of integrating human-like personality traits within the dialogue system. Think of this as the indy version of big tech companies' robots. We developed a flexible, innovative model of personality based on a multi-dimensional representation. Our proprietary Personality Font model is trained on a substantially large quantity of speeches, interviews and Tweets, spoken by actual, opinionated people. The data we collect is manually labeled by experts according to a carefully crafted set of rules, which map semantic and pragmatic features, such as function, intent, sentiment, and syntax. Machine learning algorithms are trained on our data set in order to match the input from the user to the most appropriate answer, in terms of accuracy, but also injecting humorous and subjective features into the conversation. The result is a library of virtual assistants who talk to you in a caricatured version of their human alter ego. This creates a much more engaging, enjoyable, human-like conversation.

Our dialogue engine is based on a supervised neural model or supervised statistical model. It is trained on a large quantity of speech acts or natural language text from different sources, such as transcriptions from famous politicians, which ensure highly opinionated and subjective content (jokes, funny remarks, insults). Our dialogue engine's encoded linguistic and pragmatic features enriches the complexity of the language and the function of the specific utterances. The data is labeled according to semantic and pragmatic features such as function, intent and sentiment. The data is then used to train a machine learning algorithm to match the linguistic and semantic features extracted from the input query with the most appropriate parameters to influence the agent's reply. This machine learning module is coupled with an innovative framework of human personality.

A neural network model is trained on our data set in order to match the input from the user to the most appropriate answer in terms of accuracy, but also including humorous and subjective features into the conversation. In particular, we use a Long Short-term Memory recurrent neural network for this task, because it is able to learn latent structures from sequence-based input (i.e., natural language text). The LSTM is trained on the annotated data and is then used to predict the conversation-relevant features to apply to new instances of dialogue.

We implemented this complex model in an API, integrated with state-of-the-art Natural Language Processing functions, to allow developers to create personality-aware, customized conversational agents that can adapt to different communication scenarios. The diagram shows the architecture of the system.

We integrate two complete pipelines for Natural Language Understanding (lexical and morpho-syntactic analysis, semantic parsing, sentiment and topic modeling) and Natural Language Generation (content determination, micro-planning, surface realization). The NLU pipeline is augmented by a supervised model based on neural networks that predicts the pragmatic aspects of the language and connects to the personality matrix to inform the NLG pipeline to produce the most suitable personality for the conversation and the user. The dialogue follows a realistic pattern, by including questions and remarks from the VIP to continue the conversation (aka “threading”). How the conversation develops is also influenced by the particular conversational agent's personality.

We further introduce a formal model of human personality, based on a multi-dimensional representation of a number of features relevant to the dialogue. This framework allows us to customize the tone of the dialogue according to several parameters, and to adapt it dynamically to the specific user.

The personality model is used at both ends of the conversation. In the natural language understanding (NLU) module, the user input is analyzed and classified according to features relevant to the tone of the conversation. At generation time (NLG), the agent's replies are filtered based on its personality traits and the pragmatic features that fit the current conversation best. A carefully crafted set of rules maps the semantic and pragmatic features extracted from the text to the appropriate dimensions of the personality matrix, allowing the conversational engine to “read” the personality of the user in the NLU phase and producing the most suitable replies in the NLG phase.

The technology we developed is implemented in an API: our tool to build personality-enhanced conversational agents using the architecture described beforehand. By integrating our API, developers can create conversational agents, e.g. chatbots for websites, that are able to: 1) understand the topic as well as the tone of the conversation; 2) match the input with the most appropriate response; 3) include personalized remarks and conversational prompts into the interaction.

Our API implements a full-fledged pipelines for NLU and NLG, comprising lexical, morphological and syntactic analysis, semantic parsing and sentiment analysis in the NLU module, and content determination, macro-planning, micro-planning and surface realization in the NLG module. We leverage available state-of-the-art libraries such as the Stanford Parser¹ and SimpleNLG² for Natural Language Processing, and high-level libraries for parallel neural computation like Keras, and connect the together mapping their respective representations with custom code. The diagram depicts the system architecture in detail. In the NLU module, a series of tasks are carried out in sequential order: tokenization (word and sentence segmentation), morpho-syntactic analysis, lexical analysis (classification of the meaning of the words), sentiment analysis (extraction of subjective opinions and their polarity) and topic modeling (classification of the topic of the discourse). The NLG pipeline also follows a standard architecture: macro-planning (deciding what to say), micro-planning (deciding how to structure the utterance) and surface realization (transforming the content representation in a coherent linear form, i.e. a sentence). The macro-planning module is informed by the content of the input extracted by the NLU module. The micro-planning module is instead informed by the personality model.

A conversational threading module is responsible for keeping the conversation alive, by including extra content at the end of the replies. These could be traditional conversational prompts (“how are you?”“fine, and you?), requests for clarification (“look for Chinese restaurants in the area” “there are four, when do you want to have dinner?”), or more personality-driven remarks such as funny comments or friendly banter. The latter type of conversational threading is new and made possible by the integration of the personality matrix into the NLU/NLG pipeline. Specifically, the personality traits influence the function of the reasoner module that decides what type of conversational style (that includes threading) should be produced.

In one embodiment, a personality agent is based upon a real person or fictitious character. The personality is recognizable yet dynamic due to continual training and updating of the utterance database.

In another embodiment, we developed the personality matrix, a simple yet flexible theoretical model of personality based on a multi-dimensional representation. It is matrix of static personalities defined by a user. An example of an application of this scenario where our technology applies is customer service. A personality-aware conversational agent, i.e., a chatbot, is capable of identifying angry or dissatisfied customers, therefore adjusting the conversational tone accordingly. Similarly, the agent may identify a highly educated speaker, and select a personality from the matrix of the “academic” dimension. User interface and engagement are improved when interacting with a psycho-socially matched personality. Corporations which conduct a high volume of customer service calls may use the present dialogue engine to build a customized conversational agent that understands and generates natural language according to your client's personality.

The conversational devices pair with the mobile device of the user and are ready to start a conversation. They do what other general-purpose virtual assistants do, namely answering question by looking up Wikipedia, search for Website and videos, managing the calendar, playing music, and retrieving info such as weather forecast. However, instead of sounding like the usual robotic know-it-all companion, they interact with their user (or between themselves!) in quirky and funny ways, thanks to their unique personality encoded in their dialogue engine.

The application also includes popular assistant functions, including alarms, calendar, weather, and sports. What's a better way to wake up than mariachi ringtones? How about Mr. President warning you to “get to work or be fired!”, with our library of pre-recorded wake up calls! Keep forgetting to bring an umbrella to work? Not if Dear Leader advises you of 80% chance of nuclear showers, with our custom weather updates! The personality models add layers of humor to dialog while processing assistant commands. For example, rather then saying, “The alarm is set”, the agent may add an insult or a joke, such as “You better wake up or you'll be fired,” or, “That's very late, do you really want to sleep in”, whereby increasing the engagement and enjoyment of interacting with the agent.

The application may also stream music according to the agent's reported preferences, observed dialog themes, or recurring words. In the event that the agent is modeled after a musician, the application may also stream music created by that musician. A music licensing model is described in the claims.

Other interactive conversational features include:
Dictation—A user may speak through their conversational device using the device's voice in real time by entering voice or text phrases in your mobile app. This feature is useful for playing pranks on another person.
Device to Person Interaction—A user may conduct unique and hilarious conversations with their device about anything from current events to the best way to marinate a steak.
Device to Device Interaction—A user may position two or more devices together to start an endless group conversation about idiosyncratic topics.
Messaging—A user may send and share voice messages from their phone by speaking or typing phrases, selecting a voice font, adding a character emoji, then hitting Send.

The inventors contemplate “digital swag”, or graphic assets associated with a conversational agent, which may be selected from a library of assets, and purchased. The digital assets mighty include clothes, or other artifacts typically associated with the agent. A pricing strategy may price the conversational and interactive features discussed herein, whereby enabling some features as built-in, and some unlocked upon purchase.

Users may instruct their device to activate sleep mode by addressing the agent by their namesake, and uttering a command.

The user interface indicates to a user when they are engaged in an audio chat with others.

Device pairing data and conversation history may be stored on a paired device, such as a smartphone, or locally on the device, or in a remote data center. Devices may have unique digital certificate or signature which identify the device to a paired computer or smartphone. This affinity between account and serial number prevents unauthorized access to your information.

The trade name for said conversational agents is ‘Personality Font’. A Personality Font is a virtual assistant trained with speech patterns from speakers belonging to defined psychological profiles. Whereas a voice font is solely an audial representation of speech, based on voice recordings, Personality Fonts refer to the selection of words in a conversation. Beyond voice fonts, a Personality Font is a model designed with specific voice, syntactic, lexical, semantic, and psychological parameters. Each user-selected personality model will generate contextually-appropriate conversation, so, the same question will elicit different responses from each font.

The NLU pipeline labeling system is further defined by:
Semantic Labels:
   Tone of voice (Assertive, Candid, . . . )
   Topical context (Border-wall, Chauvinism . . . )
   Sentence function (Greetings-Hello, Boast, Statement of Facts . . . )
   Sentence type (Statement, Question . . . )
Lexical and Syntactic Labels:
   Quantity of nouns, pronouns, verbs, etc
   Filler words (um, . . . )
   Ratios among parts of speech, lexical density
   Speaking rate, pauses
   Word repetition, etc.
Speaker Demographic Profile:
   Gender
   Age
   Education Level
   Mini-Mental State Exam
Pairing or Threading:
   Contextually appropriate response pairs: If “Apology”, then “Accept-Apology”, If “Greetings-Hello”, then “Greetings-Hello”
   Topically appropriate response pairs: If “Immigration”, then “Immigration”
   Personality-model appropriate response pairs: A male conversational agent will generate responses for male human or male agent using male pronouns, and language appropriate for age group.
   Tonally appropriate response pairs: If “Demeaning”, then “Defensive”
   Scripted conversation threaders: If “Statement-end” then “Add Question”, for example, “That's what I think.” >> Then Add “What do you think?”

### NON-PATENT RESOURCES

http://changingminds.org/techniques/conversation/articles/articles.htm

https://en.wikipedia.org/wiki/Syntactic_category

http://www1.appstate.edu/~mcgowant/grice.htm

http://ipip.ori.org/AlphabeticalItemList.htm

https://console.bluemix.net/docs/services/personality-insights/science.html#science

https://venturebeat.com/2013/10/11/how-ibms-michelle-zhou-figured-out-my-personality-from-200-tweets-interview/view-all/

https://developers.goggle.com/actions/design/how-conversqtions-work#repair

https://developers.google.com/actions/discovery/

https://developers.google.com/actions/design/principles

https://carla.umn.edu/articulation/polia/pdf files/communicative functions.pdf

https://www.aisb.org.uk/events/oebner-prize

https://www.statista.com/statistics702926.united-states-digital-voice-assistants-survey-usage/

https://www.stanford.edu/software/ex⋅parser,shtml

https://github.com/simplenlg/simplenlg

1. We claim a personality-based conversational model, comprised of:
a. A speech-recognition application programming interface (API), which converts audial speech into text;
b. A natural language generation (NLU) pipeline, which parses incoming speech by means of multiple labeling mechanisms;
c. A neural network, which is further comprised of a linguistic and semantic feature vector, a long-short term memory model (LSTM), which is further comprised of a pragmatic model, which is dynamically trained by substantial quantities of user speech to form a personality model;
d. A personality model, which is further comprised of a personality matrix, application specific parameters, and pragmatic mapping feature, which form the unique manner in which a person or agent converses;
e. A rule-based reasoner, which is further comprised of an inference engine, and a pairing or threading model; which understand the meaning of the speech input and begins the defines a contextually-appropriate response via the pairing model;
f. A natural language generation (NLG) pipeline, which is further comprised of a macro-planning feature for determining content and threading, a micro-planning feature for determining language style, and surface realization; which form an appropriate response to the speech input, in the character of the personality agent;
g. An utterance or speech database, harvested from speech samples of a specific person or character;
h. A speech synthesizer, or text-to-speech API;
Wherein user speech input is fed into the NLU pipeline for labeling, and simultaneously into the neural network, for dynamic training of a personality model; then said input speech, now labeled, and definitions from the personality model, feed together into the inference engine; the inference engine parses the meaning of the incoming speech, then the pairing model selects a type of appropriate response; with these instructions, the NLG engine selects words or phrases from the utterance database, then plans a response using instructions from the pairing model and the personality model, whereby generating a personality-specific reply in text format; whereby a text-to-speech function converts the text into audial format; whereby creating a personality-based and contextually-appropriate response within a conversation.

2. The Natural Language Understanding (NLU) Pipeline of claim 1 which is comprised of:
a. Sentence and word segmentation of speech input,
b. Part-of-speech tagging,
c. Morphological analysis,
d. Semantic parsing (semantic role labeling (SRL)),
e. Sentiment analysis,
f. Topic modeling (Latent Dirichlet allocation (LDA));
whereby the NLU pipeline generates a linguistic and semantic feature vector, which is then fed as input to a long-short term memory (LSTM) to learn a pragmatic model; wherein the NLU pipeline is applied identically at the time of training the model and at prediction time.

3. The labeling mechanisms of claim 2 which label input speech according to the following classifications:
a. Conversation topics, such as “Politics”, “Celebrities”, “Finance”, “Weather”;
b. Context, which is a sub-topic of Conversation topics, such as “North-Korea”, “nuclear-weapons”, “2016-election”;
c. Sentence Type, wherein the labels include a question, statement, command, or exclamation;
d. Sentence Function, wherein the labels include Directive, Interpersonal, Referential, or Imaginative;
e. Sentence Sub-Function, which is further categorized as sub-topics of Directive (such as, “persuading someone”, “forbidding someone to do something”, “giving directions”), Interpersonal (such as, “agree”, “apologize”, “give thanks”); Referential (“explain how something works”, “identify objects”), and Imaginative (“suggest ideas”, “create rhymes”).
f. Tone, such as “Derisive”, “Detached”, “Dignified”, “Diplomatic”, “Direct”;
wherein each sentence may be labeled with more than one sentence sub-function, tone, sub-topic, to accommodate multiple nuances in a single phrase or sentence;
whereby said labeling pipeline generates a linguistic and semantic feature vector, which feeds into the pragmatic model;
whereby after labeling and training on large quantities of data, the pragmatic model ranks the most often occurring labels of each category, whereby the combination of these ranked labels create a unique conversational style, associated with a personality agent, which is an approximation of the real person or character's conversational style.

4. The Natural Language Generation (NLG) algorithm of claim 1 which is comprised of:
a. A rule-based reasoner or inference engine, which is further comprised of an inference engine and a pairing model for selecting and crafting threaders, wherein a threader is a secondary utterance, which forms part of or the entire response, and is designed to elicit continued conversation from the other speaker; wherein the threader contains common themes or words identified from the input text;
b. An NLG pipeline, which is comprised of macro-planning, micro-planning and surface realization; the macro-planning module is responsible for deciding the content of the replies, based on the knowledge produced by the inference engine and on the pragmatic features produced by the mapping between the input and the agent's personality matrix; the micro-planning transforms the abstract representation of the discourse given by the macro-planning into a lexico-syntactic structure; the surface realization module is responsible for linearizing the syntax tree and producing the correct word forms inflections, word order, punctuation and optional prosody information for the speech synthesis module;
Whereby the NLG pipeline selects an appropriate utterance from an utterance database and processes it though said pipeline; the rule-based reasoner applies to the macro-planning component of the NLG pipeline; the NLG pipeline generates a response to the input, plus a threader,
Whereby generating speech which resembles the unique word choice, intent, and tone of the original speaker's character.

5. We claim a mechanism for generating humorous responses, wherein the natural language

4. ion module of claim 4, selects the most appropriate response according to factors including:
a. sentence length, wherein, if given a choice between a longer or shorter response to select from the utterance database, the NLG pipeline will select the shorter; wherein the preferred response length of utterances selected from the utterance database is 10 words or less;
b. semantic ambiguity of lexical items in the utterance database, or double entendres, according to the number of contextual meanings of the content words (nouns, adjectives and verbs), whereby selects lexical items with a plurality of contextual meanings, whereby purposely producing ambiguous responses, which are subject to multiple interpretations including humorous ones; wherein underspecification in the generation of pronouns as referring expressions is used to augment the ambiguity level of the sentence with the goal of producing a humorous response
c. conversational topics of “low brow” humor;
d. frequent use of insults;
e. juxtaposition of conversational agents whose human models are generally in conflict with each other, whereby content from real world conflicts may be inferred if not explicitly stated in the dialog;
f. taunts regarding gender, sexual orientation, sexual prowess, size of body parts, nationality, or other sensitive, immutable personal characteristics;
g. answering a question with a question;
h. earnest discussion of mundane subjects by namesakes of substantial influence, whereby creating a juxtaposition of size and power;
wherein the shorter and more ambiguous the response, or the more multiple nuanced meanings may be interpreted, enable humorous interpretations of the response and threader which may vary according to context.

6. We claim a response pairing mechanism, of the NLG pipeline of claim 4, wherein dialog flows between two or more agents by means of connecting or leading words or phrases, called threaders, pairing, or adjacency pairing, which are attached to the NLP output or comprise the NLP output in its entirety; wherein a set of rules matches the labels ascribed to the input to a possible range of matching labels in the output; wherein said pairing is comprised of a keyword or key sub-topic common to both NLU input sentences and NLG utterance database; the keyword having charged contextual qualities, such as sexual, political or emotional labels; wherein the selected keyword may ambiguous, or a double entendres, whose meaning may change from input to output context; whereby the response may or may not be contextually aligned to the input, yet reflects the speaker's unique and slanted perspective; whereby creating a humorous interchange; whereby enabling the topic of conversation to shift and flow as the keywords' vectors shift.

7. The speech generation of claim 1, which is additionally recognizable by a deep neural network voice API, otherwise known as a voice font, which converts NLG-generated text generated into speech, which is trained on the audial portion of the person or fictitious character's speech samples, which in conjunction with conversational parameters, including lexical, syntactic, speech markers, and intentions, and vocabulary, create recognizable caricatures of politicians, historical figures, celebrities, musicians, fictional characters, athletes, or other recognizable entities.

8. The utterance database of claim 1 which dynamically scrapes source language from a specific real person's or fictitious character's interviews, Tweets, speeches, movie scripts, and other recordings; whereby pre-processes the utterances prior to being fed to the NLG pipelines, wherein said pre-processing includes substantially the same training, parsing, and labeling stages from the NLU model described in claim 1, and further cleaning of extraneous punctuation, such as hashtags, weblinks, emojis, and other characters associated with web-based language; whereby converts acronyms into their source words; whereby converts slang abbreviations into their source words; whereby the utterance database regularly retrieves new utterances from the speaker's public media accounts, or other third-party reporting sources, whereby enabling the conversational agent of claim 1 to remain contemporaneous in context and subject matter; whereby the utterances populate the NLG pipeline by means of an application programming interface.

9. The personality-based conversational model of claim 1 wherein patterns of linguistic and semantic feature vectors from large quantities of input speech from one specific user generate a speech profile, or personality font, of a conversational agent, which determines the style of conversation and natural language generation; which may be further defined by:
a. Static Speaker Demographic Profile, including the age, education level, gender, and native tongue of the speaker;
b. Dynamic patterns of lexical quantifiers identified in the NLU pipeline, including but not limited to: quantity of nouns, pronouns, and verbs per sentence; filler words; ratios among parts of speech; lexical density; speaking rate; pauses; and word repetition; wherein the average range is noted over a large sample of a person's speech;
c. Dynamic syntactic quantifiers identified in the NLU pipeline including but not limited to Skewness (MFCC 8), Stajner-Mitkov measure of sentence complexity (COM); TTR; Lexico-syntactic markers such as NP→PRP, p p MMSE average length, prp_ratio, coordinate phrases per clause, complex T-units per T-unit, number of dependent clauses, and mean Yngve depth;
d. Dynamic tonal, semantic, and topical preferences;
Wherein the static labels and the most common recurring dynamic labels form a profile of a distinct personality agent or model;
whereby the NLG engine pipeline will select content, threading, and language style consistent with said labels; whereby speech generated by this model is consistent, recognizable, and characteristic of a person, real or artificial.

10. We claim a second embodiment of a conversational agent, in which a speech personality matrix, comprised of a series of dimensions corresponding to linguistic and pragmatic features of a desired speech style, rather than a specific person, whereby encoding any specific personality font into a vector of categorical values, wherein one personality is encoded in this model by one permutation of a matrix of selected lexical-semantic values;
whereby the personality matrix permutations are extendible both in terms of additional dimensions and additional categorical values “n” for the existing dimensions;
whereby forming a matrix of permutationsₙ×ₙ× and so forth, corresponding to speech styles,
whereby the personality matrix is a static module, that is, it is predefined and not subject to statistical training procedures;
whereby the permutations form a searchable library of distinct conversational agents, or Personality Fonts, generated by permutations of conversational attributes,
whereby each resulting permutation is labeled for identification.

11. The personality matrix of claim 10 wherein the permutation labels or dimensions include:
a. interpersonal attitude, with possible values ranging from “opinionated” to “agreeable”,
b. loquaciousness, with possible values ranging from: “chatty” to “terse”,
c. and educational level, with possible values ranging from” simple” to “academic”.

12. An application programming interface comprised of the personality matrix of claim 10, an NLU engine, and a personality pairing mechanism, wherein the NLU pipeline dynamically parses a substantially small sample of a human's input speech to determine the human's mood and personality vector, then the pairing mechanism selects one permutation, or static personality font, of the personality matrix, as an appropriate conversational partner, whereby improving the human-computer interaction.

13. A conversational device comprised of:
a. conversational API of claim 1, corresponding to a specific personality agent;
b. a sculptural, diminutive caricature of a person, historical figure, fictional character, politician, celebrity, or branded personalities;
c. a pedestal which enables listening and speaking with another device or person, housing a microphone, a speakerphone, a controller, a processor, networking hardware, in/out port, and a power supply;
whereby said device may sense speech commands and emit audio responses, and process responses locally using algorithms of claim 1 preprogrammed on said processor, or process responses remotely by querying a remote computer by means of said networking hardware, and emit responses or music or alarms;
whereby said networking hardware enables regular updating of speech content from a remote source;
whereby the physical manifestation of the person enables a more skeuomorphic interaction with artificial intelligence, so a user may interact with said device in a substantially similarly as if interacting with its namesake.

14. A mobile or desktop interactive application, which provides a visual interface for the conversational agent of claim 1, affording dictation functionality, into which one or more users may dictate or type speech, whereby the application converts the speech into audio files, whereby sending the audio files to the physical device which is paired to the remote computer via wireless protocol, whereby the device's speaker emits the speech in its associated voice font, whereby affording the user to may be physically removed from the device, whereby creating an opportunity for humorous situations such as pranks.

15. A mobile or desktop interactive application which provides an interface for the conversational agent of claim 1, which offers messaging functionality, wherein a user may dictate or type a message into a conventional text messaging application, select a Personality Font from a library, whereby said application converts the user's message from text into an audio file of the Personality Font's voice, whereby a user may then send the audio file to other users via SMS, email, or share on social media.

16. A mobile or desktop interactive application, which provides an interface for the conversational agent of claim 1, wherein a user may converse with a conversational agent selected from a library of agents, or may select two or more agents to converse with each other, wherein the dialog is actively displayed as text overlaid on still images, or streaming video of the devices, using augmented reality technology.

17. A mobile or desktop interactive app which provides a customized music streaming and shuffling feature, based on a conversational agent of claim 1, wherein the music tracks are selected from a database by matching themes or words in the music to the agent's dominant themes, or, if the agent is based on a musician, then the music is a selection of the musician's songs.

18. The conversational agent of claim 1 wherein the agent executes preprogrammed commands associated with a personal assistant, such as purchasing goods or services, setting alarms, fetching data such weather updates, alarm clock functions, sports scores, trivia, wherein applying a voice and personality vector associated with a specific personality model, generates additional language to create a humorous or more engaging interaction.

19. A revenue model wherein users may purchase digital accessories for the avatar of their personality model or device, as shown in their smartphone or desktop application of claim 14, whereby the accessories may include graphic representations of clothing, animals, holiday-specific objects, or other artifacts or symbols, whereby enabling customization of a user's avatar and humorous interaction of multiple avatars.

20. A commercial licensing model whereby a person, or a corporation representing the personality assets of a person or a fictional character, may license their personality, as described by physical appearance, voice, and speech, for the creation of a conversational device of claim 1, by providing speech samples for generation of a voice font, NLU training, and utterance database, and images of the person for the purpose of modeling a three-dimensional sculpture or two-dimensional digital image; whereby a user may converse with said digital agent as a proxy of the real person; wherein revenue is generated for the person or corporation from the purchase of the device, a subscription to the digital conversation, music streaming, or assistant services, commissions on purchases of third-party goods and services made through the agent, purchases of digital swag made through an app, royalties from music streamed through the device, or combination thereof.
